(19) United States
(12) Patent Application Publication
(10) Pub. No.: US 2019/0199987 A1
(43) Pub. Date: Jun. 27, 2019

(54) HEAD-UP DISPLAY SYSTEM

(71) Applicant: VALEO COMFORT AND DRIVING ASSISTANCE, Créteil (FR)

(72) Inventor: Cedric LESSORT, Créteil (FR)

(73) Assignee: Valeo Comfort and Driving Assistance, Créteil (FR)

(21) Appl. No.: 16/091,657

(22) PCT Filed: Apr. 5, 2017
(86) PCT No.: PCT/EP2017/058167

§ 371 Date: Mar. 5, 2019

(30) Foreign Application Priority Data
Apr. 5, 2016 (FR) 1600579

(51) Int. Cl. H04N 9/31; G02B 27/01

(52) U.S. Cl. CPC H04N 9/3185; G02B 2027/014; G02B 27/0101

(57) ABSTRACT

The invention relates to a head-up display system comprising: a processing module (1) designed to determine modified data representing a deformed image according to initial data representing an original image and deformation data defining an image deformation; a device (2) for generating a light beam representing the deformed image; and a projection device (3) designed to project the light beam in an adjustable direction towards a semi-transparent panel (4). The processing module (1) is designed to select the deformation data from a deformation table according to the adjustable direction.

### TECHNICAL FIELD TO WHICH THE INVENTION RELATES

The present invention relates to head-up display techniques, for example those used in motor vehicles.

It more particularly relates to a head-up display system.

The invention is particularly advantageously applicable in the case where the projection direction of the light beam is adjustable and where it is desired to limit the consumption of memory.

### TECHNOLOGICAL BACKGROUND

Head-up display systems are known that comprise a processing module designed to determine modified data representing a warped image depending on initial data representing an original image and on warping data defining an image warpage, a device for generating a light beam representing the warped image and a projecting device designed to project the light beam in an adjustable direction onto a semi-transparent plate.

Provision is made in this case to use a different set of warping data for each projection direction potentially adopted by the projecting device, this leading to a substantial consumption of memory.

### SUBJECT OF THE INVENTION

In this context, the present invention proposes a head-up display system such as defined above, characterized in that the processing module is designed to select said warping data from a warping table depending on said adjustable direction.

The warping data are thus chosen depending on the region of the semi-transparent plate that receives the light beam, this being enough to define the desired warpage, and it is not necessary to define the warpage to be applied separately for each of the envisioned projection directions.

According to features that are optionally envisionable:
the warping table comprises data used to determine the data representing the warped image when the projecting device projects the light beam in a first direction and when the projecting device projects the light beam in a second direction different from the first direction;
the data of the warping table define, for each of a plurality of projection directions, an association between each pixel of the original image and an associated pixel of the warped image;
for a given projection direction, the warping table contains, for each pixel of the warped image, a record (located at a location in the warping table and) defining the coordinates of the associated pixel in the original image;
the warping table comprises a number of records strictly higher than the number of pixels of the warped image and strictly lower than the product of the number of pixels of the warped image multiplied by the number of light-beam projection directions provided for in the projecting device;
the projecting device comprises a folding mirror and a mechanism for inclining the folding mirror, designed to adjust said projection direction;
the processor is designed to receive instructions and to determine angular setpoints intended for the projecting device and/or data designating the selected warping data, depending on the received instructions;
the semi-transparent plate is a combiner or, as a variant, a windshield of the vehicle equipped with the head-up display system.

### DETAILED DESCRIPTION OF ONE EXAMPLE EMBODIMENT

The following description with reference to the appended drawings, which are given by way of nonlimiting example, will allow of what the invention consists and how it may be carried out to be clearly understood.

In the appended drawings:

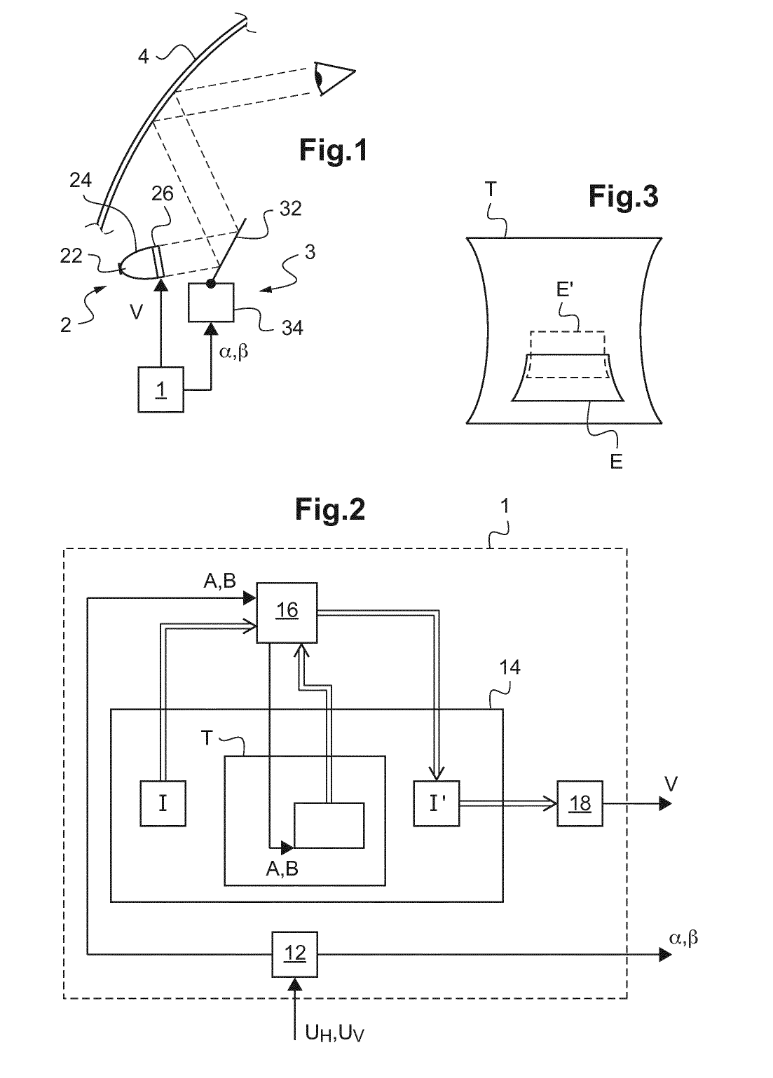

FIG. 1 shows a head-up display system according to the invention;

FIG. 2 shows the main elements of a processor of the system of FIG. 1; and

FIG. 3 schematically shows the warpage created by the warping table T.

FIG. 1 schematically shows the main elements of a head-up display system for a vehicle (here for a motor vehicle).

This head-up display system comprises a processor 1, a device 2 for generating a light beam, a device 3 for projecting the light beam in a variable direction and a semi-transparent plate 4.

The semi-transparent plate 4 is for example the windshield of the vehicle. As a variant, it could be a question of a (dedicated) combiner, generally placed between the windshield of the vehicle and the driver of the vehicle.

The generating device 2 is designed to generate the light beam depending on a video signal V produced by the processor 1.

The generating device 2 here comprises a light source 22, a reflector 24 and a screen 26 to which the video signal V is applied. The screen 26 is for example a liquid-crystal display (or LCD) or a thin-film transistor (or TFT) display.

The light emitted by the light source 22 and reflected by the reflector 24 is transmitted through the screen 26 so as to form the aforementioned light beam. The transmittance of each pixel of the screen 26 is adjusted depending on the video signal V (and optionally for the various colors taken into account in the video signal V) so that the transmitted light beam corresponds to the image represented by the video signal V.

As a variant, the generating device 2 could comprise a diffuser the back face of which is scanned by a light beam of variable intensity (and color), according to the video signal V, so that the front face of the diffuser emits a light beam once again corresponding to the image represented by the video signal V.

The projecting device 3 is arranged so as to transmit the light beam generated by the generating device 2 in the direction of the semi-transparent plate 4, where the light beam is partially reflected in the direction of the driver of the vehicle so as to superpose the image formed by this light beam on the exterior environment of the vehicle, which is also seen by the driver through the semi-transparent plate 4.

As already indicated, the projecting device 3 is designed so as to be able to make, for example on command by the driver, the direction in which the light beam is transmitted by the projecting device 3 vary. This allows the region of the semi-transparent plate 4 that reflects the light beam in the direction of the driver to be varied, in order for example to optimally adapt the system to the size of the driver.

The projecting device 3 here comprises a folding mirror 32 arranged so as to reflect, in the direction of the semi-reflective plate 4, the light beam generated by the generating device 2, and a mechanism 34 for inclining the folding mirror 32 depending on angular setpoints α, β received from the processor 1.

Specifically, provision may for example be made for the inclining mechanism 34 to allow the inclination of the folding mirror 32 to be varied about two different axes: for example, the angular setpoint α corresponds to an inclination of the mirror 32 about an almost-vertical axis and the angular setpoint β corresponds to an inclination about a horizontal axis. Thus, an adjustment of the setpoint α leads to a horizontal movement of the image projected by the projecting device 3, whereas an adjustment of the setpoint β leads to a vertical movement of the projected image.

As a variant, the inclining mechanism 34 could make the inclination of the folding mirror 32 vary only in one direction, for example in order to adjust only vertically the position of the projected image (by means of the setpoint β). The following description may be easily transposed to this case by systematically setting α=0.

FIG. 2 shows those elements of the processor 1 that are useful to the comprehension of the invention.

The processor 1 here takes the form of a microcontroller.

The processor 1 comprises a control module 12 (here a microprocessor), a memory 14 (here a direct-access memory), a graphics processing module 16 (here a graphics engine) and a graphics controller 18.

The memory 14 in particular stores data (called initial data) representative of an original image I and a warping table T.

The original image I is a matrix array of pixels having a horizontal resolution h and a vertical resolution v. The original image I is therefore defined by a number of pixels equal to the product h×v of the horizontal resolution multiplied by the vertical resolution v.

The original image I is the image that it is desired to present to the driver. This original image I for example contains symbols representing operating parameters of the vehicle (such as the instantaneous speed of the vehicle or the engine speed of the vehicle) and/or indications given by a navigation system.

The original image I is for example generated by a module (not shown) for managing the display. Such a module for managing the display may be integrated into the processor 1 (in which case the module for managing the display may write to the memory 14 the data representative of the original image I). As a variant, the module for managing the display may be implemented by another electronic unit (which then for example transmits the data representative of the original image I to the processor 1 via an on-board computer network with a view to storage of these data in the memory 14).

The warping table T defines the warpage to be applied to the original image I for a plurality of directions of transmission of the light beam by the projecting device 3.

To do this, the warping table T defines an association between each pixel of the original image I and an (associated) pixel of an image (here of same horizontal resolution h and of same vertical resolution v) obtained by the warpage, or the warped image I′, and does so for a plurality of directions of transmission of the light beam by the projecting device 3.

The warped image I′ is therefore here defined by a number of pixels that is identical to the number of pixels defining the original image I, which number is equal, as indicated above, to the product h×v of the horizontal resolution h multiplied by the vertical resolution v.

Provision is here made, for a given direction of transmission of the light beam by the projecting device 3, for the warping table T to contain, for each pixel of coordinates (x′, y′) in the warped image, a record located at a location (A+x′, B+y′) in the warping table T and defining the coordinates (x, y) of the associated pixel in the original image I (where the variables A and B depend on the aforementioned direction of transmission, as explained below).

Because the warping table T contains data (called warping data, here contained in the aforementioned records) relative to a plurality of possible projection directions of the light beam, the number of records stored in the warping table T is strictly higher than the number of pixels of the original image I and warping image I′.

The control module 12 receives instructions U_{H}, U_{V} that are indicative of the position desired by the user for the display of the image generated by the head-up display system. This position is for example adjusted by the user via interaction with a user interface, which transmits the instructions U_{H}, U_{V} to the control module 12. Provision is here made for the instruction U_{H} to correspond to the horizontal adjustment desired by the user for the display and for the instruction U_{V} to correspond to the vertical adjustment desired by the user for the display.

The control module 12 determines the angular setpoints α, β associated with the instructions U_{H}, U_{V}, respectively (for example, for each setpoint α, β, by reading from a look-up table) and transmits these angular setpoints α, β to the inclining mechanism 34 as already indicated (in the variant mentioned above in which only a vertical adjustment is possible, only the instruction U_{V} is used and the control module 12 then only determines the angular setpoint β).

The control module 12 moreover determines which data of the look-up table T define the warpage D(α, β) to be applied when the projecting device 3 is configured by applying the angular setpoints α, β.

Provision is here made for the warping data to be used in the warping table T to be defined by a location (A, B) within this warping table T.

The control module 12 in this case determines this location (A, B) depending on the angular setpoints α, β; here precisely the abscissa A of the location (A, B) is determined depending on the angular setpoint α and the ordinate B of the location (A, B) is determined depending on the angular setpoint β.

In the variant mentioned above in which the adjustment of the position of the projected image is carried out in the vertical direction only (α=0), A will always be set to 0.

The control module 12 then transmits information indicative of the data to be used (here the coordinates (A, B) of the location defining these data) to the graphics processing module 16.

It will be noted that, in the example described here, the control module 12 is integrated into the processor 1 (here a microcontroller) comprising the graphics processing module 16. As a variant, the control module 12 and the graphics processing module 16 could be implemented in two different electronic circuits.

The graphics processing module 16 may thus apply to the image I the warpage D(α, β) defined by those data of the warping table T that are designated by the control module 12 (here by the location (A, B) received from the control module 12).

For example, if the initial data defining the image I comprise a brightness value L(x, y) for each pixel of coordinates (x, y), each pixel of coordinates (x′, y′) in the warped image I′ will have the following brightness value: L′(x′, y′)=L(T(A+x′, B+y′)), where T(A+x′, B+y′) represents the coordinates in the image I that are stored in the warping table T in the location (A+x′, B+y′).

Here, for the sake of simplification of the description, mention is only made of the brightness defining the original image I or the warped image I′. In practice, the images I, I′ may furthermore be defined by chrominance values, or, as a variant, by brightness values associated with a plurality of colors (typically red, green and blue), respectively.

The modified data (here the brightness values L′) defining the warped image I′ are stored by the graphics processing module 16 in the memory 14.

The graphics controller 18 may thus generate a video signal V representative of the warped image I′ (stored in the memory 14 as indicated above).

Thus, the generating device 2 generates a light beam corresponding to the warped image I′.

This light beam corresponding to the warped image I′ is transmitted (here by reflection from the folding mirror 32) in the intended direction using the angular setpoints α, β and is reflected from the semi-transparent plate 4 in a corresponding region.

The warping table T is designed such that the warpage D(α, β) applied to the image I (as indicated above) counterbalances the warpage resulting from the reflection from a non-planar surface in the aforementioned region of the semi-transparent plate 4 (and optionally warpage created by the folding mirror 32).

FIG. 3 schematically shows the warpage created by the warping table T, which covers all of the positions envisioned for the display of the image.

Specifically, because the warpage to be applied depends on the site of reflection of the light beam from the semi-transparent plate 4, the data of the warping table T to be used depend on the region in which the image to be displayed is reflected from the semi-transparent plate 4.

Thus, if a given region of the semi-transparent plate 4 is used for two different positions of display of the image (corresponding to two different directions of transmission of the light beam by the projecting device 3), the data of the warping table T that relate to this region will be used to determine the modified image I′ in each of the two positions (even if these data will be applied to different pixels for one position and for the other position).

For example, if a dataset E (here a sub-table of locations of h×v size, referenced by a location (A₀, B₀)) defines the warpage D(α₀, β₀) to be applied to the original image I when the angular setpoints α₀, β₀ are applied to the projecting device 3 and if a dataset E′ (here a sub-table of locations of h×v size, referenced by a location (A₁, B₁)) defines the warpage D(α₁, β₁) to be applied to the original image I when the angular setpoints α₁, β₁ are applied to the projecting device 3, there are data that are common to the dataset E and to the dataset E′ when a region of the semi-transparent plate is used to reflect the displayed image in the two aforementioned configurations (this occurring here when |A₀−A₁|<h and |B₀−B₁|<v).

Reusing the notation employed below, a record located in a location (a, b) of the warping table T will thus possibly be used:
when the angular setpoints α₀, β₀ are applied to the projecting device, to determine the brightness L′(x′,y′) of the pixel of coordinates (x′,y′) of the modified image I′ such that a=A₀+x′ and b=B₀+y′ (specifically it will be recalled that in this case: L′(x′, y′)=L(T(A₀+x′, B₀+y′)));
when the angular setpoints α₁, β₁ are applied to the projecting device, to determine the brightness L′(x″,y″) of the pixel of coordinates (x″,y″) of the modified image I such that a=A₁+x″ and b=B₁+y″ (since then: L′(x″, y″)=L(T(A₁+x″, B₁+y″))).

In other words, it is not necessary to use a different warping table for each possible projection direction. The warping table T thus comprises a number of records strictly lower than the product of the number of pixels (here h×v) of the warped image I′ multiplied by the number of light-beam projection directions provided for in the projecting device 3.

1. A head-up display system comprising:
a processing module for determining modified data representing a warped image based on initial data representing an original image and on warping data defining an image warpage;
a device for generating a light beam representing said warped image; and
a projecting device for projecting the light beam in an adjustable direction onto a semi-transparent plate, wherein
said processing module selects said warping data from a warping table depending on said adjustable direction.

2. The head-up display system as claimed in claim 1, wherein the warping table comprises data used to determine the data representing the warped image when the projecting device projects the light beam in a first direction and when the projecting device projects the light beam in a second direction different from the first direction.

3. The head-up display system as claimed in claim 1, wherein the data of the warping table define, for each of a plurality of projection directions, an association between each pixel of the original image and an associated pixel of the warped image.

4. The head-up display system as claimed in claim 1, wherein, for a given projection direction, the warping table contains, for each pixel of the warped image, a record defining the coordinates of the associated pixel in the original image.

5. The head-up display system as claimed in claim 4, wherein the warping table comprises a number of records strictly higher than the number of pixels of the warped image and strictly lower than the product of the number of pixels of the warped image multiplied by the number of light-beam projection directions provided for in the projecting device.

6. The head-up display system as claimed in claim 1, wherein the projecting device comprises a folding mirror and a mechanism for inclining the folding mirror to adjust said projection direction.

7. The head-up display system as claimed in claim 1, wherein the processor further receives instructions and determines, depending on the received instructions, angular setpoints for the projecting device and data designating the selected warping data.

8. The display system as claimed in claim 1, wherein the semi-transparent plate is a combiner.

9. The display system as claimed in claim 1, wherein the semi-transparent plate is a windshield.
